(19) United States
(12) Patent Application Publication
(10) Pub. No.: US 2020/0373744 A1
(43) Pub. Date: Nov. 26, 2020

(54) WIRING TOOL

(71) Applicants: Paul Danelski, Apple Valley, MN (US); Judd A. Jackson, Grant, MN (US)

(72) Inventors: Paul Danelski, Apple Valley, MN (US); Judd A. Jackson, Grant, MN (US)

(21) Appl. No.: 16/882,340

(22) Filed: May 22, 2020

Related U.S. Application Data
(60) Provisional application No. 62/851,865, filed on May 23, 2019.

(51) Int. Cl. H02G 1/00; B25G 1/12

(52) U.S. Cl. CPC H02G 1/00; H02G 3/12; B25G 1/12

(57) ABSTRACT

A tool suitable for wiring applications in a wide variety of commercial and residential wiring tasks. The tool is hand held article having both a wire pushing feature and a wire pulling feature that supports the movement and placement of wires without abrading, scraping, scratching, or damaging the coating or shield on the wire or the wire itself.

### TECHNICAL FIELD

A hand held tool useful for pulling, connecting, and locating wires for electrical and communication services in both commercial and residential wiring applications. The tool includes multiple features that enable a wide variety of tasks in wiring applications and practices.

### BACKGROUND

Commercial and residential wiring often requires various tasks that require retrieval or placement of wiring. Often individuals performing such tasks utilize any tool that is available such as a screwdriver, pliers or the like. Use of such tools can abrade, scrape, scratch, or damage the coating or shield applied over the wiring. This is damage could short or damage the wire that is being connected, typically to an outlet or wiring fixture. Such damage may not be readily known or recognized until after the installation has been completed. This in turn creates inefficiencies in the installation process and may require the re-wiring of the intended outlet or fixture.

### SUMMARY

This disclosure is directed to a tool suitable for wiring applications in a wide variety of commercial and residential wiring tasks. The tool is an article having a handle with a shaft extending from the handle. A tooling element is located at the distal end of the shaft. The tooling element includes a wire pushing feature and a wire pulling feature. The wire pushing feature and wire pulling feature may take various shapes or configurations that enable the specific function addressing wiring tasks in commercial or residential applications. This wiring tool enables the connection and placement of wires without abrading, scraping, scratching, or damaging the coating or shield on the wire or the wire itself.

The wire pulling and pushing features are useful in locating and placing wire in various applications and setting. In some embodiments, the tooling element includes inverted features that enable directional manipulation and placement of wires in, for example, a wiring receptacle, outlet or fixture. Certain aspects of the tooling element offer assistance in multiple directions or in opposing directions, such as pushing or pulling features. For purposes of this disclosure the terms pushing feature or pulling feature do not connote a device for moving wires in a single vector, but rather encompass a general direction.

### BRIEF DESCRIPTION OF DRAWINGS

FIG. 1 is a schematic of one embodiment of the wiring tool.

FIGS. 2 (a-g) are illustrations of various cross-sectional embodiments of a shaft described in this disclosure.

FIG. 3 is a pictorial version of the device of this disclosure in use with an electrical receptacle.

FIG. 4 is a pictorial version of on embodiment the device of this disclosure.

### DETAILED DESCRIPTION

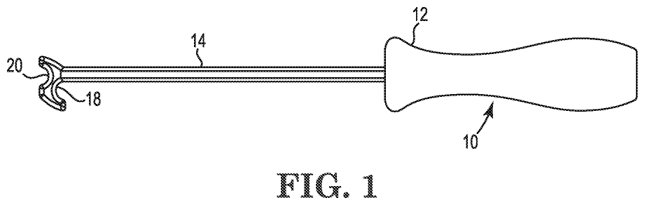

FIG. 1 depicts one embodiment of the wiring tool 10 of this disclosure. The wiring tool 10 includes a handle 12 with a shaft 14 fixed in or integrally formed with the handle 12. A tooling element 16 is located at the distal end of the shaft 14. The tooling element possesses a pulling feature 18 along with a pushing feature 20. The pulling feature 18 and the pushing feature are illustrated in this embodiment as depressions in the tooling element.

The handle of the wiring tool may be formed in various shapes and sizes to allow and end user to manipulate and use the wiring tool by hand. More specifically, the intent of the handle is to allow the user of the wiring tool to manipulate the tooling element at the end of the shaft through the handle. Embodiments of the handle may include gripping grooves or even textured surfaces to enable a solid grasp of the tool. In alternative embodiment, an elastomeric coating may be affixed or molded to the outer surface of the handle. In a preferred embodiment, the handle is a dielectric material. In another embodiment, the handle is integrally formed with the shaft, the tooling element or both.

The shaft of the wiring tool extends the tooling element at a distance from the handle. Those of ordinary skill in the art will recognize that the length of the shaft may vary widely to offer access to many different kinds of wiring applications. In certain embodiments, the shaft is a made of a dielectric material to prevent electrical conduction. Various dielectric materials may be used, including polymeric materials. In another embodiment, the shaft may include an angle or bend to accommodate specific applications or receptacles where a straight shaft is unable to reach or access wiring or a location in the receptacle.

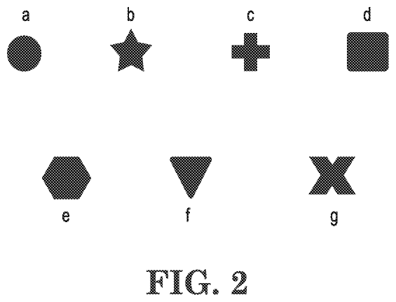

The shaft of the wiring tool may also possess various shapes or sizes. The varying shapes and sizes may be selected to offer structural integrity, aesthetic features, or both. Non-limiting examples of shapes of the shaft are depicted in FIGS. 2 (a-g) and include a circle (a), a star (b), a cross (c), a square (d), a polygon (e), a triangle (f), or an “X” shape (g). Those of ordinary skill in the art are capable of selecting a specific shape to accommodate a particular end use, a specific material choice, or a manufacturing process.

The tooling element of the wiring tool functions as a contact point with the wires. The tooling element is placed at the distal end of the shaft and is in communication with the handle. Manipulation of the handle in turn controls the tooling element. The tooling element is intended to allow for multi-directional placement and movement of wires, co-axial cables, or the like. In certain embodiments, the tooling element includes a wire pushing feature and a wire pulling feature. The terms pushing and pulling are used in this disclosure to indicate movement in multiple directions, not just directionally opposing movement. For example, the tooling element can move or place wires in various vectors or directions required to complete a wiring application and the installation of wire receptacles or the like.

In some embodiments, the pushing and pulling features of the tooling element includes various shapes to allow a user to employ the wiring tool in many different applications. Non-limiting examples of either the pushing feature or the pulling feature comprise a shape selected from a partial-circle, a partial oval, a partial ellipse, a curve, a partial square, or a partial rectangle. The use of the term partial indicates that the shape is open to allow engagement of the wire.

In one embodiment, the wire pushing feature or the wire pulling feature comprise a single structural element. One non-limiting example of a single structural element is illustrated in FIG. 1. The wire tooling element 16 includes a single structure that encompasses both the wire pulling feature 18 and the wire pushing feature 20. In this particular example, the single structural element is depicted as an s-shaped feature. Those of ordinary skill in the art recognize that other single structural features may be suitable for offering both wire pulling and wire pushing functions.

A wide variety of materials may be employed to construct the entirety, or components the disclosed wire tool. The materials may include metals, polymers, wood, or combinations thereof.

In some embodiments, the disclosed wire tool may be manufactured as a single unit. For example, the material used in constructing the wire tool may be a polymer. Polymers offer unique structural and physical properties, such as being light weight easily melt processed, and still possess suitable mechanical and physical integrity to function without adverse consequences involving fatigue or failure. Additionally, polymers may enable the efficient manufacture of the wire tool through melt processing techniques, such as for example injection molding.

A wide variety of polymers conventionally recognized in the art as suitable for melt processing are useful as the polymeric matrix. They include both hydrocarbon and non-hydrocarbon polymers. Examples of useful polymeric matrices include, but are not limited to, polyamides, polyimides, polyurethanes, polyolefins, polystyrenes, polyesters, polycarbonates, polyketones, polyureas, polyvinyl resins, polyacrylates, and polymethylacrylates.

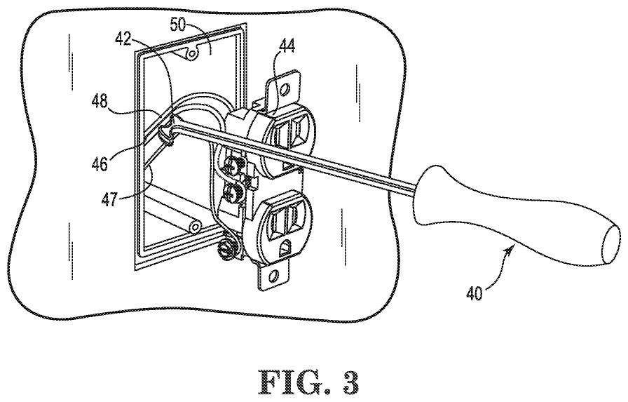

FIG. 3. is an illustration of the disclosed wire tool in use. The wiring tool 30 is utilized to push wires 32 connected to electrical outlet 34 back into the receptacle 36. The wire pushing feature 38 engages the wires 32 and effectively moves them rearward into the receptacle 36. The use of the wiring tool prevents the user from attempting to move wires by hand and potentially expose an individual to electrical shock. Additionally, the wiring tool eliminates the need to use another tool that could potentially abrade, scrape, scratch, or damage the coating or shield on the wire or the wire itself. An exposed wire could also be a safety issue if a standard screwdriver or other conductive tool is used to move wires.

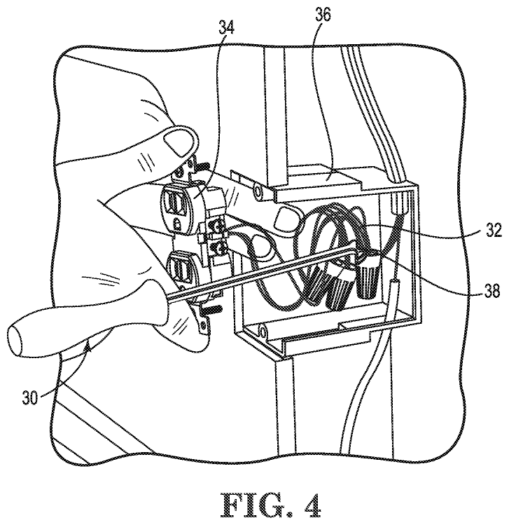

FIG. 4. demonstrates the use of the wire pulling feature 42 of the wiring tool 40. The wire pulling feature 42 is used to engage wires 46, 47, 48 connected to outlet 44. As the outlet 44 is pulled out or away from receptacle 50, the wire pulling feature 42 is used to engage the wires 46, 47, 48 and pull them out of receptacle 50 as the outlet 44 is being removed.

Although specific embodiments have been illustrated and described herein for purposes of description of the preferred embodiments, it will be appreciated by those of ordinary skill in the art that a wide variety of alternate or equivalent implementations calculated to achieve the same purposes may be substituted for the specific embodiments shown and described without departing from the scope of the present invention. This application is intended to cover any adaptations or variations of the preferred embodiments discussed herein. Therefore, it is manifestly intended that this invention be limited only by the claims and the equivalents thereof.

What is claimed is:

1. An article comprising, a wiring tool having a handle, a shaft extending from the handle, and a tooling element on the distal end of the shaft, wherein the tooling element includes a wire pushing feature and a wire pulling feature.

2. An article according to claim 1, wherein the wiring tool, the shaft, or the handle comprise an injection molded polymer.

3. An article according to claim 1, wherein the handle comprises gripping grooves or textured surface.

4. An article according to claim 1, wherein the wiring tool, the shaft, the handle or a combination thereof comprise a dielectric material.

5. An article according to claim 1, wherein the shaft comprises a cross-sectional shape selected from a circle, a star, a cross, a square, a polygon, triangle or x-shape.

6. An article according to claim 1, wherein the pushing feature or the pulling feature comprise a shape selected from a partial-circle, a partial oval, a partial ellipse, a curve, a partial square, or a partial rectangle.

7. An article according to claim 1, wherein the wire pushing feature or the wire pulling feature comprise a single structural element.

8. An article according to claim 7, wherein the single structural element comprises an s-shaped feature.

9. An article according to claim 1, wherein at least a portion of the wiring tool comprises a polyamides, polyimides, polyurethanes, polyolefins, polystyrenes, polyesters, polycarbonates, polyketones, polyureas, polyvinyl resins, polyacrylates, and polymethylacrylates.

10. A method comprising forming a wiring tool having a handle, a shaft extending from the handle, and a tooling element on the distal end of the shaft, wherein the tooling element includes a wire pushing feature and a wire pulling feature.

11. A method according to claim 10, wherein the wiring tool is injection molded.

12. A method according to claim 10, wherein at least a portion of the wiring tool comprises a polyamides, polyimides, polyurethanes, polyolefins, polystyrenes, polyesters, polycarbonates, polyketones, polyureas, polyvinyl resins, polyacrylates, and polymethylacrylates.

13. An article according to claim 10, wherein the handle comprises gripping grooves or surface.

14. An article according to claim 10, wherein the wiring tool, the shaft or the handle comprise a dielectric material.

15. An article according to claim 10, wherein the shaft comprises a cross-sectional shape selected from a circle, a star, a cross, a square, triangle, or X-shape.

16. An article according to claim 10, wherein the pushing feature or the pulling feature comprise a shape selected from a partial-circle, a partial oval, a partial ellipse, a curve, a partial square, or a partial rectangle.

17. An article according to claim 10, wherein the wire pushing feature or the wire pulling feature comprise a single structural element.

18. An article according to claim 17, wherein the single structural element comprises an s-shaped feature.
